(19) United States
(12) Patent Application Publication
(10) Pub. No.: US 2013/0293442 A1
(43) Pub. Date: Nov. 7, 2013

(54) ANTENNA HAVING CONNECTING CIRCUIT

(71) Applicant: YAGEO CORPORATION, Kaohsiung (TW)

(72) Inventors: BOON-TIONG CHUA, KAOHSIUNG (TW); CHIH-YANG LOU, KAOHSIUNG (TW); TSUNG-YAO CHIU, KAOHSIUNG (TW); CHUNG-JEN CHIU, KAOHSIUNG (TW)

(73) Assignee: YAGEO CORPORATION, KAOHSIUNG (TW)

(21) Appl. No.: 13/680,573

(22) Filed: Nov. 19, 2012

(30) Foreign Application Priority Data
May 4, 2012 (TW) 101115875

(51) Int. Cl. H01Q 1/48

(52) U.S. Cl. CPC H01Q 1/48
USPC 343/906

(57) ABSTRACT

The present invention relates to an antenna having a connecting circuit, which includes a substrate, a grounding metal strip, a first radiating metal strip, a second radiating metal strip and a connecting circuit. The first radiating metal strip is not connected to the grounding metal strip or the second radiating metal strip. The connecting circuit connects different positions on the grounding metal strip and on the second radiating metal strip, so as to form a plurality of resonant paths of different lengths between the grounding metal strip and the second radiating metal strip. Thereby, the frequency of the antenna varies between different values, so that the range of the application and the practicality of the antenna are increased.

### BACKGROUND OF THE INVENTION

1. Field of the Invention

The present invention relates to an antenna, and in particular, to an antenna having a connecting circuit to switch the frequency.

2. Description of the Related Art

With vigorous development of a wireless communication technology, various multi-frequency communication products have sprung up. Therefore, wireless communication products gradually become a part of human life. Almost all new products are provided with a wireless transmission function, so as to meet public demands (for example, a notebook computer or a mobile multimedia device is often required to transmit data). The wireless transmission may save a lot of troubles in wiring and setting. In order to achieve the objective of wireless transmission, configuration of a wireless transmission antenna is necessary.

However, currently, a conventional antenna of the wireless communication product can only operate at a fixed frequency after being manufactured. Therefore, a small sized antenna generally fails to cover a frequency required by a user, which restricts use of the antenna.

Therefore, it is necessary to provide an innovative and progressive antenna having a connecting circuit to solve the above problem.

### SUMMARY OF THE INVENTION

The present invention provides an antenna having a connecting circuit, comprising a substrate, a grounding metal strip, a first radiating metal strip, a second radiating metal strip and a connecting circuit. The first radiating metal strip is attached to the substrate, wherein the first radiating metal strip is not connected to the grounding metal strip. The second radiating metal strip is attached to the substrate, wherein the second radiating metal strip is not connected to the first radiating metal strip, and a gap between the first radiating metal strip and the second radiating metal strip is less than 5 mm. The connecting circuit is attached to the substrate, and used for electrically connecting different positions on the grounding metal strip and on the second radiating metal strip, so as to form a plurality of resonant paths of different lengths between the grounding metal strip and the second radiating metal strip, wherein the first radiating metal strip radiates at least one first resonant mode, and the second radiating metal strip is coupled to the first radiating metal strip to produce at least one second resonant mode; the resonant paths are switched via the connecting circuit, so that the frequency of the second resonant mode varies between different values.

The present invention also provides an antenna having a connecting circuit, comprising a substrate, a grounding metal strip, a first radiating metal strip, a second radiating metal strip and a connecting circuit. The substrate has a first surface. The first radiating metal strip is located on the first surface of the substrate, wherein the first radiating metal strip is not connected to the grounding metal strip. The second radiating metal strip is located on the first surface of the substrate, wherein the second radiating metal strip is not connected to the first radiating metal strip, and the first radiating metal strip is located between the second radiating metal strip and the grounding metal strip. The connecting circuit is located on the first surface of the substrate, and used for electrically connecting different positions on the grounding metal strip and on the second radiating metal strip, so as to form a plurality of resonant paths of different lengths between the grounding metal strip and the second radiating metal strip, wherein the first radiating metal strip radiates at least one first resonant mode, and the second radiating metal strip is coupled to the first radiating metal strip to produce at least one second resonant mode; the resonant paths are switched via the connecting circuit, so that the frequency of the second resonant mode varies between different values.

### BRIEF DESCRIPTION OF THE DRAWINGS

FIG. 1 illustrates a schematic view of an antenna of the present invention being disposed on a screen housing frame of a notebook computer;

FIG. 2 illustrates a schematic partially enlarged view of an antenna of the present invention being disposed on a screen housing frame of a notebook computer;

FIG. 3 illustrates a schematic view of an antenna having a connecting circuit according to an embodiment of the present invention;

FIG. 4 illustrates a schematic view of an antenna having a connecting circuit according to another embodiment of the present invention;

FIG. 5 illustrates a schematic view of an antenna having a connecting circuit according to another embodiment of the present invention;

FIG. 6 illustrates a schematic view of an antenna having a connecting circuit according to another embodiment of the present invention;

FIG. 7 illustrates a schematic view of an antenna having a connecting circuit according to another embodiment of the present invention;

FIG. 8 illustrates a schematic view of an antenna having a connecting circuit according to another embodiment of the present invention;

FIG. 9 illustrates a schematic view of an antenna having a connecting circuit according to another embodiment of the present invention;

FIG. 10 illustrates a schematic view of an antenna having a connecting circuit according to another embodiment of the present invention;

FIG. 11 illustrates a schematic view of an antenna having a connecting circuit according to another embodiment of the present invention; and

FIG. 12 illustrates a schematic view of an antenna having a connecting circuit according to another embodiment of the present invention.

### DETAILED DESCRIPTION OF THE INVENTION

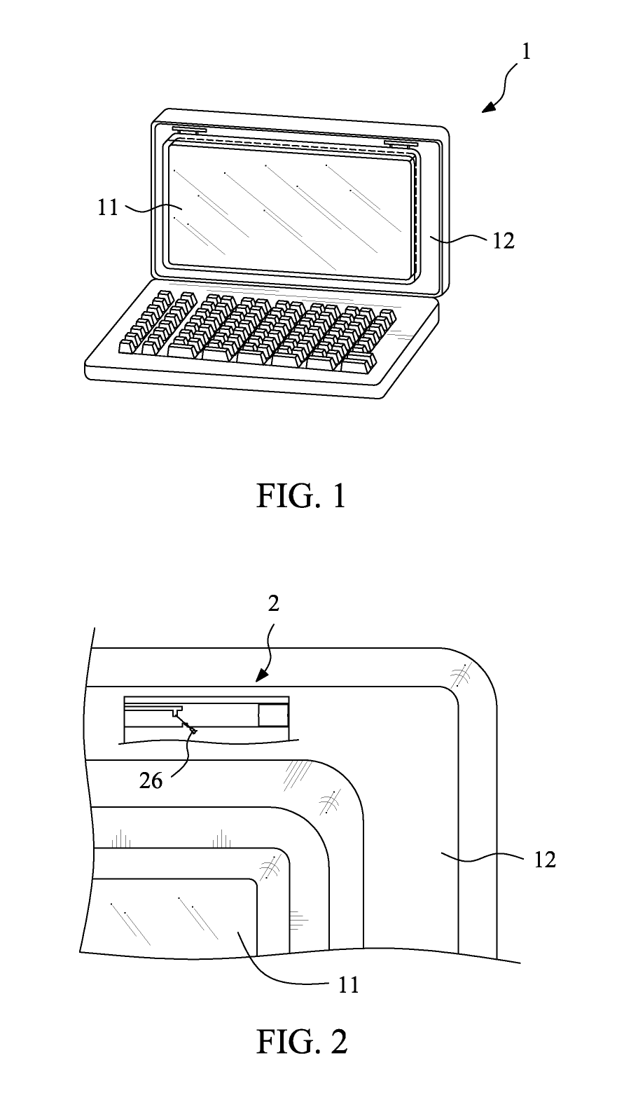

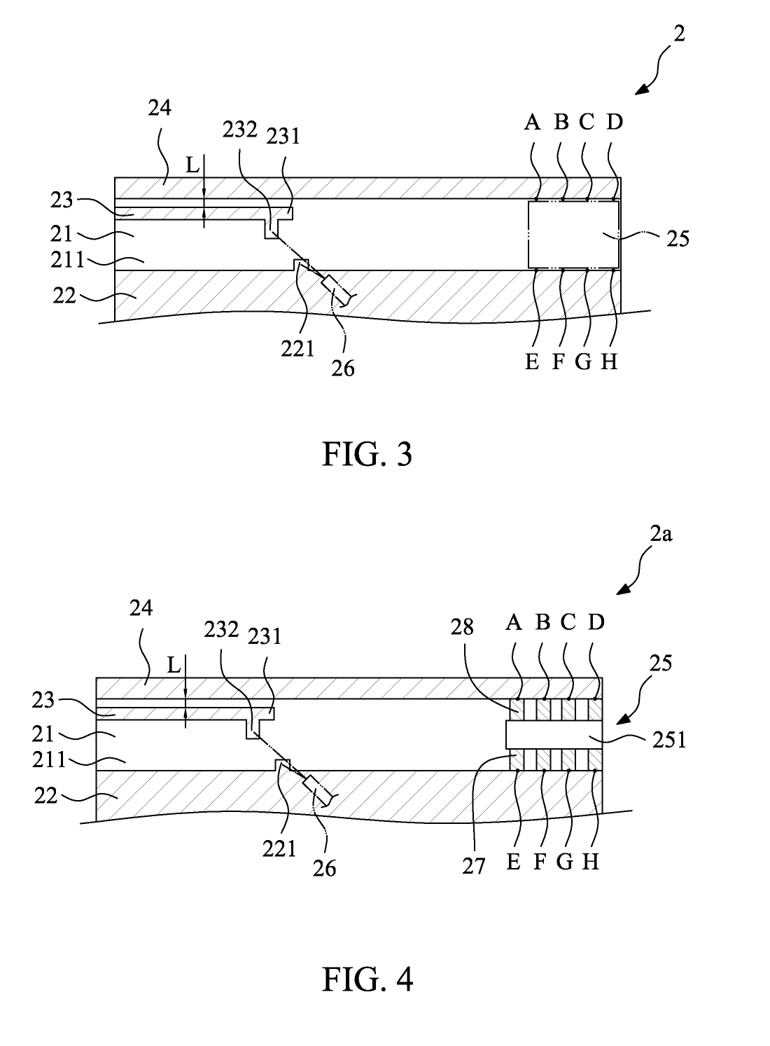

Referring to FIG. 1 and FIG. 2, a schematic view and a schematic partially enlarged view of an antenna of the present invention being disposed on a screen housing frame of a notebook computer are respectively illustrated. The antenna of the present invention may be applied to various wireless electronic devices, which include, but are not limited to the notebook computer. Other electronic products, such as an ordinary personal digital assistant (PDA), may also use the antenna of the present invention to achieve an objective of wireless communication. The notebook computer 1 has a screen 11 and a screen housing frame 12. The antenna 2 (shown in FIG. 3) of the present invention is disposed on the screen housing frame 12 of the notebook computer 1, and the antenna 2 is connected to a controlling circuit of the notebook computer 1 through a coaxial line 26, so as to use the antenna 2 for data transmission.

The antenna 2 has at least one joint structure used for fixing the antenna 2 onto the screen housing frame 12. In this embodiment, the joint structure is an adhesive layer (not shown), which is located on the back of the antenna 2, and is used for adhering the antenna 2 to the screen housing frame 12.

Referring to FIG. 3, a schematic view of an antenna having a connecting circuit according to an embodiment of the present invention is illustrated. The antenna 2 includes a substrate 21, a grounding metal strip 22, a first radiating metal strip 23, a second radiating metal strip 24, a connecting circuit 25 and a coaxial line 26.

The substrate 21 has a first surface 211. The material of the substrate 21 is selected from the group consisting of plastic, foamed plastic, ceramic, FR-4, a printed circuit board and a flexible printed circuit board. Preferably, the dielectric constant of the substrate 21 is greater than that of the first radiating metal strip 23 and that of the second radiating metal strip 24, so as to achieve the function of reducing the frequency.

The grounding metal strip 22 is used for grounding, and includes a grounding point 221 and at least one first electrical connection point. The grounding metal strip 22 is attached to the first surface 211 of the substrate 21. In this embodiment, the grounding metal strip 22 includes a plurality of first electrical connection points E, F, G, and H, and the first electrical connection points E, F, G, and H are located on the top end of the grounding metal strip 22 and are arranged along a horizontal direction. Preferably, the antenna 2 further includes an auxiliary grounding metal strip (not shown), which is adhered to the grounding metal strip 22. The auxiliary grounding metal strip may be of an aluminum foil material.

The first radiating metal strip 23 is attached to the first surface 211 of the substrate 21. The first radiating metal strip 23 is not connected to the grounding metal strip 22, the second radiating metal strip 24 and the connecting circuit 25. That is, the first radiating metal strip 23 is independent from the grounding metal strip 22, the second radiating metal strip 24 and the connecting circuit 25. In this embodiment, an area surrounded by the grounding metal strip 22, the connecting circuit 25, and the second radiating metal strip 24 is a substantially U shape, and the first radiating metal strip 23 is located within this area. The first radiating metal strip 23 is in a long strip shape, and extends along a horizontal direction from a side of the substrate 21. The first radiating metal strip 23 includes an end portion 231 and a feed point 232, in which the feed point 232 is adjacent to the end portion 231.

The second radiating metal strip 24 is attached to the first surface 211 of the substrate 21. The second radiating metal strip 24 is not connected to the first radiating metal strip 23, and the first radiating metal strip 23 is located between the second radiating metal strip 24 and the grounding metal strip 22. In this embodiment, the second radiating metal strip 24 is in a long strip shape, and extends along a horizontal direction from one side of the substrate 21 to the other side thereof. The second radiating metal strip 24 is parallel to the first radiating metal strip 23, and the length of the second radiating metal strip 24 is greater than that of the first radiating metal strip 23. The entire first radiating metal strip 23 or a part of the first radiating metal strip 23 is very close to the entire second radiating metal strip 24 or a part of the second radiating metal strip 24, so as to produce an electromagnetic coupling effect and form a resonant path. In this embodiment, the gap L between the first radiating metal strip 23 and the second radiating metal strip 24 is less than 5 mm, and preferably, less than 2 mm.

The second radiating metal strip 24 includes at least one second electrical connection point. In this embodiment, the second radiating metal strip 24 includes a plurality of second electrical connection points A, B, C, and D, and the second electrical connection points A, B, C, and D are located on the bottom end of the second radiating metal strip 24 and are arranged along a horizontal direction. Preferably, the locations of the second electrical connection points A, B, C, and D are corresponding to the locations of the first electrical connection points E, F, G, and H.

The connecting circuit 25 is attached to the first surface 211 of the substrate 21, and is electrically connected to the grounding metal strip 22 and the second radiating metal strip 24, thereby electrically connecting different positions (for example, the second electrical connection points A, B, C, and D and the first electrical connection points E, F, G, and H) on the grounding metal strip 22 and on the second radiating metal strip 24, so as to form a plurality of resonant paths of different lengths between the grounding metal strip 22 and the second radiating metal strip 24. For example, a path (containing the second radiating metal strip 24) formed after the second electrical connection point A and the first electrical connection point E are connected is defined as a first resonant path, and a path formed after the second electrical connection point B and the first electrical connection point F are connected is defined as a second resonant path, in which the length of the second resonant path is greater than that of the first resonant path.

The connecting circuit 25 may be of any layout design, as long as it can connect a path at one time and switch different paths at different times. Preferably, the connecting circuit 25 includes components such as an IC or a diode.

The coaxial line 26 has a signal end and a grounding end, which are respectively electrically connected to the feed point 232 and the grounding point 221.

In this embodiment, the material of the grounding metal strip 22, the first radiating metal strip 23, and the second radiating metal strip 24 is copper. The grounding metal strip 22, the first radiating metal strip 23, and the second radiating metal strip 24 are adhered to the first surface 211 of the substrate 21. The first radiating metal strip 23 radiates at least one first resonant mode, the frequency of which is from 1710 MHz to 2700 MHz. The second radiating metal strip 24 is coupled to the first radiating metal strip 23 to produce at least one second resonant mode. In the present invention, the resonant paths of different lengths are corresponding to different values of the frequency of the second resonant mode. That is, the resonant paths are switched via the connecting circuit 25, so that the frequency of the second resonant mode varies between different values. In this embodiment, the frequency of the second resonant mode varies between 700 MHz and 1000 MHz. For example, when A-E is connected, the frequency of the second resonant mode is from 700 MHz to 750 MHz; when B-F is connected, the frequency of the second resonant mode is from 750 MHz to 800 MHz; when C-G is connected, the frequency of the second resonant mode is from 800 MHz to 900 MHz; and when D-H is connected, the frequency of the second resonant mode is from 900 MHz to 1000 MHz.

Therefore, even if the antenna 2 is already manufactured (the size thereof is fixed), different resonant paths may be switched via the connecting circuit 25, so that the frequency of the second resonant mode varies between different values. Thereby, the range of application and the practicality of the antenna 2 may be increased.

Referring to FIG. 4, a schematic view of an antenna having a connecting circuit according to another embodiment of the present invention is illustrated. The antenna 2a in this embodiment is similar to the antenna 2 shown in FIG. 3, and the same elements are designated with the same reference numerals. The difference between the antenna 2a in this embodiment and the antenna 2 shown in FIG. 3 is described as follows. The antenna 2a has at least one first wiring 27 and at least one second wiring 28, and the connecting circuit 25 is a first switching circuit 251. The first switching circuit 251 can connect different positions on the grounding metal strip 22 and on the second radiating metal strip 24. In this embodiment, the antenna 2a has a plurality of first wirings 27 and a plurality of second wirings 28, in which the first wirings 27 are respectively connected to the first electrical connection points E, F, G, and H and the connecting circuit 25 (the first switching circuit 251), and the second wirings 28 are respectively connected to the second electrical connection points A, B, C, and D and the connecting circuit 25 (the first switching circuit 251). The first switching circuit 251 can selectively connect A-E, B-F, C-G, or D-H.

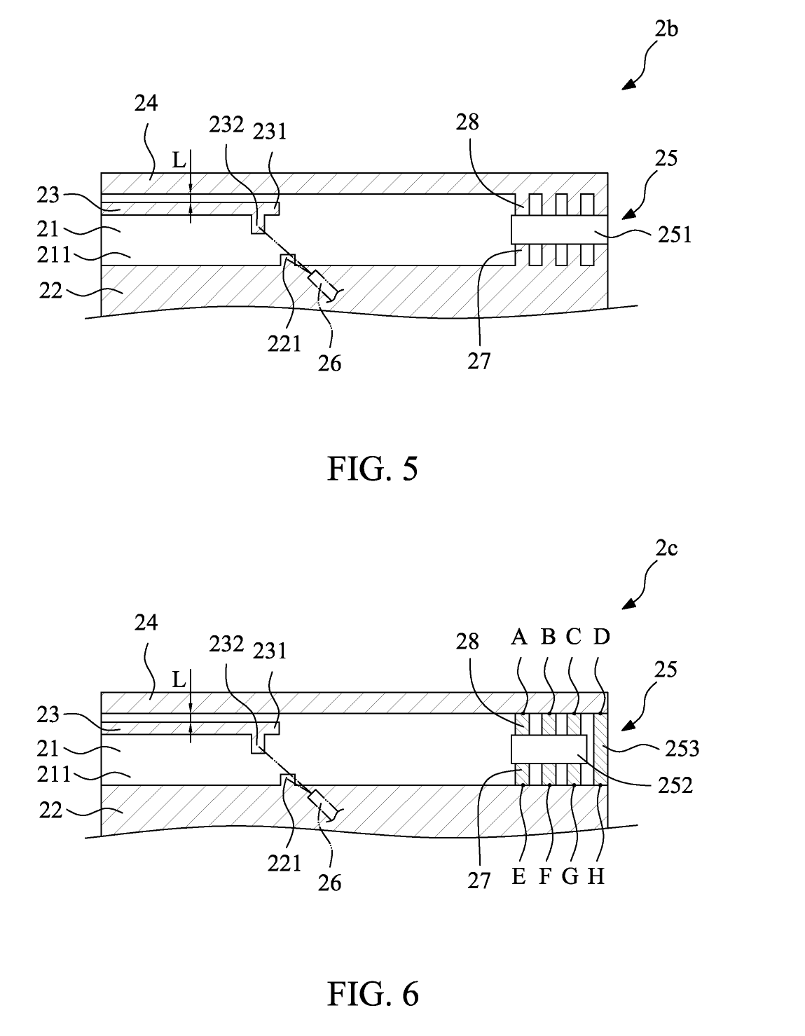

Referring to FIG. 5, a schematic view of an antenna having a connecting circuit according to another embodiment of the present invention is illustrated. The antenna 2b in this embodiment is similar to the antenna 2a shown in FIG. 4, and the same elements are designated with the same reference numerals. The difference between the antenna 2b in this embodiment and the antenna 2a shown in FIG. 4 is described as follows. In the antenna 2b of this embodiment, the first wirings 27 are integrally formed with the grounding metal strip 22, and the second wirings 28 are integrally formed with the second radiating metal strip 24.

Referring to FIG. 6, a schematic view of an antenna having a connecting circuit according to another embodiment of the present invention is illustrated. The antenna 2c in this embodiment is similar to the antenna 2a shown in FIG. 4, and the same elements are designated with the same reference numerals. The difference between the antenna 2c in this embodiment and the antenna 2a shown in FIG. 4 is described as follows. The antenna 2c has at least one first wiring 27 and at least one second wiring 28, and the connecting circuit 25 includes a second switching circuit 252 and a connecting portion 253. The connecting portion 253 is located on the first surface 211 of the substrate 21, and physically connects the first electrical connection point H of the grounding metal strip 22 and the second electrical connection point D of the second radiating metal strip 24. Preferably, the connecting portion 253 is a connecting metal strip, and the grounding metal strip 22, the connecting portion 253 and the second radiating metal strip 24 are integrally formed.

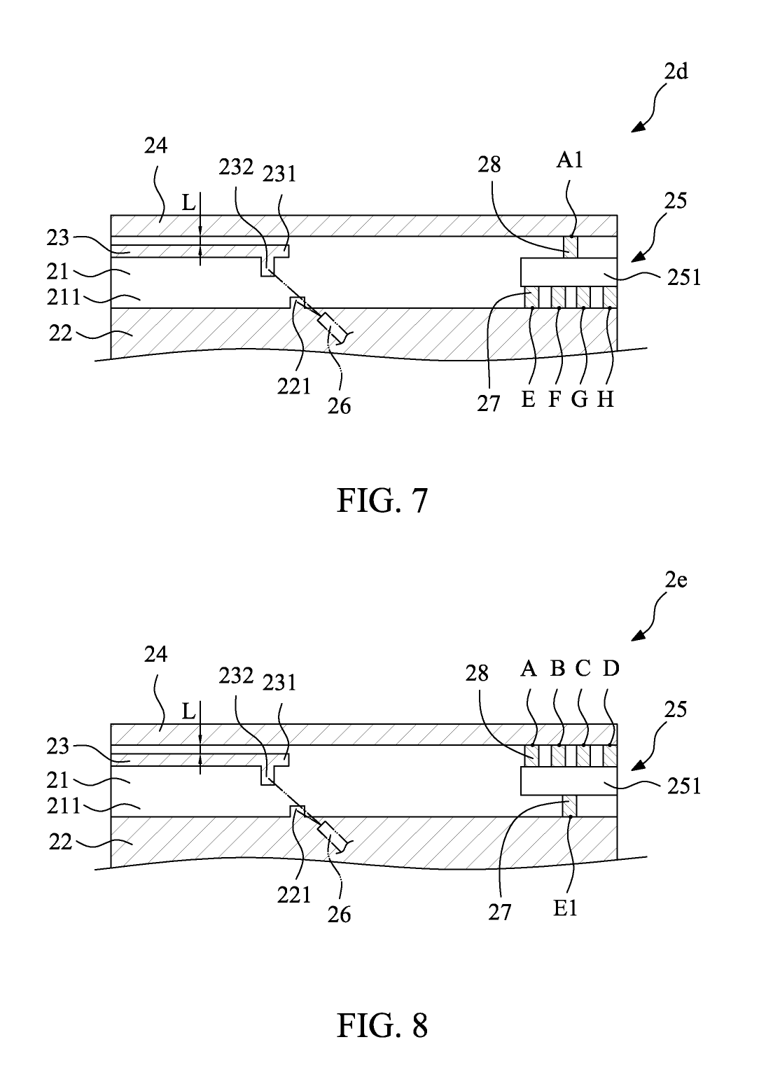

Referring to FIG. 7, a schematic view of an antenna having a connecting circuit according to another embodiment of the present invention is illustrated. The antenna 2d in this embodiment is similar to the antenna 2a shown in FIG. 4, and the same elements are designated with the same reference numerals. The difference between the antenna 2d in this embodiment and the antenna 2a shown in FIG. 4 is described as follows. In the antenna 2d of this embodiment, the grounding metal strip 22 includes a plurality of first electrical connection points E, F, G, and H, and the second radiating metal strip 24 includes a second electrical connection point A1. The antenna 2d has a plurality of first wirings 27 and a second wiring 28, in which the first wirings 27 are respectively connected to the first electrical connection points E, F, G, and H and the connecting circuit 25 (the first switching circuit 251), and the second wiring 28 is connected to the second electrical connection point A1 and the connecting circuit 25 (the first switching circuit 251). Therefore, the first switching circuit 251 can selectively connect A1-E, A1-F, A1-G, or A1-H.

Referring to FIG. 8, a schematic view of an antenna having a connecting circuit according to another embodiment of the present invention is illustrated. The antenna 2e in this embodiment is similar to the antenna 2a shown in FIG. 4, and the same elements are designated with the same reference numerals. The difference between the antenna 2e in this embodiment and the antenna 2a shown in FIG. 4 is described as follows. In the antenna 2e of this embodiment, the grounding metal strip 22 includes a first electrical connection point E1, and the second radiating metal strip 24 includes a plurality of second electrical connection points A, B, C and D. The antenna 2e has a first wiring 27 and a plurality of second wirings 28, in which the first wiring 27 is connected to the first electrical connection points E1 and the connecting circuit 25 (the first switching circuit 251), and the second wiring 28 are respectively connected to the second electrical connection points A, B, C and D and the connecting circuit 25 (the first switching circuit 251). Therefore, the first switching circuit 251 can selectively connect A-E1, B-E11, C-E1, or D-E1.

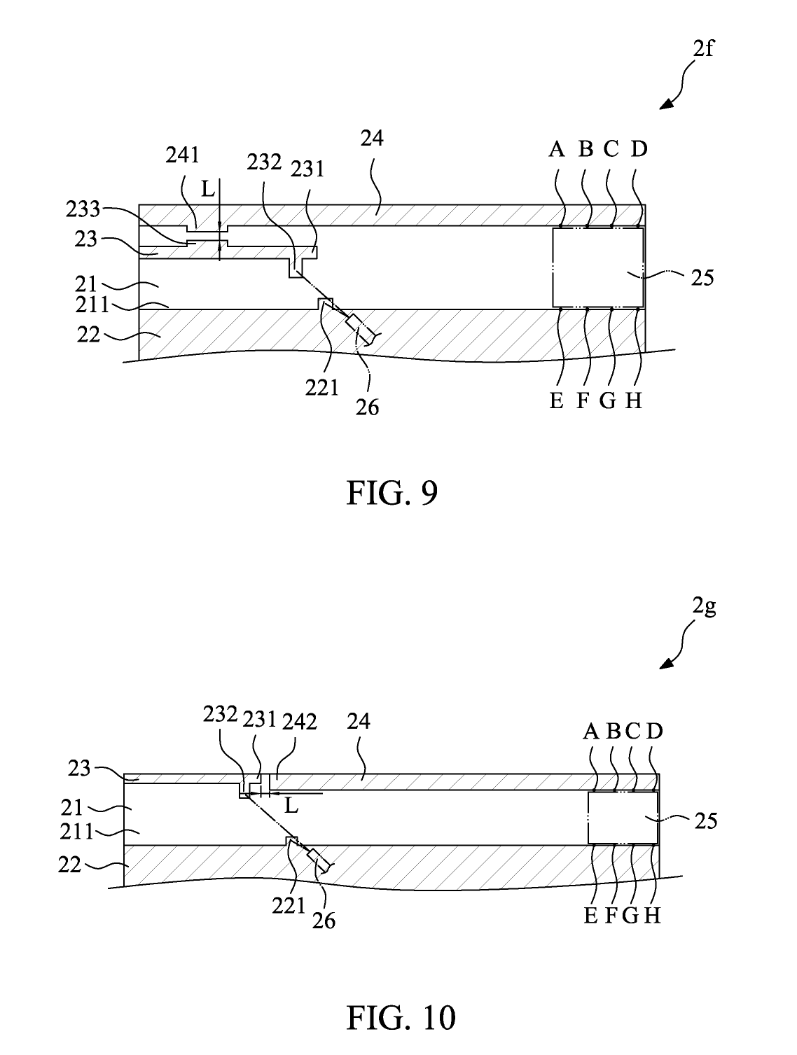

Referring to FIG. 9, a schematic view of an antenna having a connecting circuit according to another embodiment of the present invention is illustrated. The antenna 2f in this embodiment is similar to the antenna 2 shown in FIG. 3, and the same elements are designated with the same reference numerals. The difference between the antenna 2f in this embodiment and the antenna 2 shown in FIG. 3 is described as follows. In the antenna 2f of this embodiment, the first radiating metal strip 23 has a first protruding portion 233, and the second radiating metal strip 24 has a second protruding portion 241. The first protruding portion 233 faces the second protruding portion 241, and the gap L therebetween is less than 5 mm.

Referring to FIG. 10, a schematic view of an antenna having a connecting circuit according to another embodiment of the present invention is illustrated. The antenna 2g in this embodiment is similar to the antenna 2 shown in FIG. 3, and the same elements are designated with the same reference numerals. The difference between the antenna 2g in this embodiment and the antenna 2 shown in FIG. 3 is described as follows. In the antenna 2g of this embodiment, an end portion 231 of the first radiating metal strip 23 faces an end portion 242 of the second radiating metal strip 24, and a gap L between the end portion 231 of the first radiating metal strip 23 and the end portion 242 of the second radiating metal strip 24 is less than 5 mm.

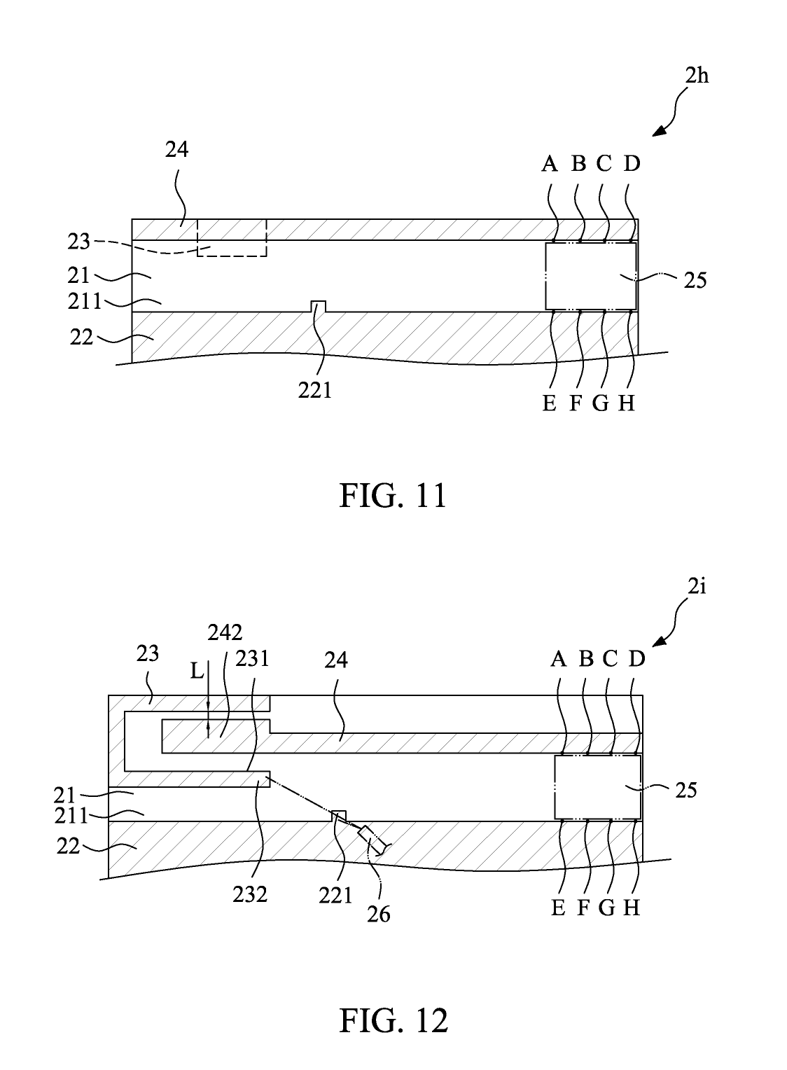

Referring to FIG. 11, a schematic view of an antenna having a connecting circuit according to another embodiment of the present invention is illustrated. The antenna 2h in this embodiment is similar to the antenna 2 shown in FIG. 3, and the same elements are designated with the same reference numerals. The difference between the antenna 2h in this embodiment and the antenna 2 shown in FIG. 3 is described as follows. In the antenna 2h of this embodiment, the grounding metal strip 22, the second radiating metal strip 24 and the connecting circuit 25 are disposed on the first surface 211 of the substrate 21, and the first radiating metal strip 23 is disposed on a second surface of the substrate 21, wherein the second surface of the substrate 21 is opposite to the first surface 211 of the substrate 21.

Referring to FIG. 12, a schematic view of an antenna having a connecting circuit according to another embodiment of the present invention is illustrated. The antenna 2i in this embodiment is similar to the antenna 2 shown in FIG. 3, and the same elements are designated with the same reference numerals. The difference between the antenna 2i in this embodiment and the antenna 2 shown in FIG. 3 is described as follows. In the antenna 2i of this embodiment, the first radiating metal strip 23 is U-shaped, and surrounds an end portion 242 of the second radiating metal strip 24. The gap L between the first radiating metal strip 23 and the end portion 242 of the second radiating metal strip 24 is less than 5 mm.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined in the appended claims.

What is claimed is:

1. An antenna having a connecting circuit, comprising:
a substrate;
a grounding metal strip;
a first radiating metal strip, attached to the substrate, wherein the first radiating metal strip is not connected to the grounding metal strip;
a second radiating metal strip, attached to the substrate, wherein the second radiating metal strip is not connected to the first radiating metal strip, and a gap between the first radiating metal strip and the second radiating metal strip is less than 5 mm; and
a connecting circuit, attached to the substrate, and used for electrically connecting different positions on the grounding metal strip and on the second radiating metal strip, so as to form a plurality of resonant paths of different lengths between the grounding metal strip and the second radiating metal strip, wherein
the first radiating metal strip radiates at least one first resonant mode, and the second radiating metal strip is coupled to the first radiating metal strip to produce at least one second resonant mode; the resonant paths are switched via the connecting circuit, so that the frequency of the second resonant mode varies between different values.

2. The antenna according to claim 1, wherein an area surrounded by the grounding metal strip, the connecting circuit, and the second radiating metal strip is substantially an U shape, and the first radiating metal strip is located within the area.

3. The antenna according to claim 1, wherein the first radiating metal strip has a first protruding portion, and the second radiating metal strip has a second protruding portion; the first protruding portion faces the second protruding portion, and a gap therebetween is less than 5 mm.

4. The antenna according to claim 1, wherein an end portion of the first radiating metal strip faces an end portion of the second radiating metal strip, and a gap between the end portion of the first radiating metal strip and the end portion of the second radiating metal strip is less than 5 mm.

5. The antenna according to claim 1, wherein the grounding metal strip, the second radiating metal strip, and the connecting circuit are located on a first surface of the substrate, and the first radiating metal strip is located on a second surface of the substrate.

6. The antenna according to claim 1, wherein the first radiating metal strip is U-shaped, and surrounds an end portion of the second radiating metal strip.

7. The antenna according to claim 1, wherein the first radiating metal strip has a feed point, the grounding metal strip has a grounding point, and the feed point and the grounding point are respectively electrically connected to a signal end and a grounding end of a coaxial line.

8. The antenna according to claim 1, wherein the connecting circuit comprises a first switching circuit, and the first switching circuit electrically connects the different positions on the grounding metal strip and on the second radiating metal strip.

9. The antenna according to claim 1, wherein the connecting circuit comprises a second switching circuit and a connecting portion, the connecting portion connects the grounding metal strip and the second radiating metal strip, the second switching circuit is located between the first radiating metal strip and the connecting portion, the second switching circuit has an open circuit state, and the grounding metal strip is not electrically connected to the second radiating metal strip under the open circuit state.

10. The antenna according to claim 9, wherein the connecting portion is a connecting metal strip, and the grounding metal strip, the connecting metal strip, and the second radiating metal strip are integrally formed.

11. The antenna according to claim 9, further comprising at least one first wiring and at least one second wiring, wherein the grounding metal strip has at least one first electrical connection point, the second radiating metal strip has at least one second electrical connection point, the at least one first wiring is connected to the at least one first electrical connection point and the second switching circuit, and the at least one second wiring is connected to the at least one second electrical connection point and the second switching circuit.

12. The antenna according to claim 1, wherein the grounding metal strip has at least one first electrical connection point, the second radiating metal strip has at least one second electrical connection point, and the connecting circuit is electrically connected to the at least one first electrical connection point and the at least one second electrical connection point.

13. The antenna according to claim 12, further comprising at least one first wiring and at least one second wiring, wherein the at least one first wiring is connected to the at least one first electrical connection point and the connecting circuit, and the at least one second wiring is connected to the at least one second electrical connection point and the connecting circuit.

14. An antenna having a connecting circuit, comprising:
a substrate, having a first surface;
a grounding metal strip;
a first radiating metal strip, located on the first surface of the substrate, wherein the first radiating metal strip is not connected to the grounding metal strip;
a second radiating metal strip, located on the first surface of the substrate, wherein the second radiating metal strip is not connected to the first radiating metal strip, and the first radiating metal strip is located between the second radiating metal strip and the grounding metal strip; and
a connecting circuit, located on the first surface of the substrate, and used for electrically connecting different positions on the grounding metal strip and on the second radiating metal strip, so as to form a plurality of resonant paths of different lengths between the grounding metal strip and the second radiating metal strip, wherein
the first radiating metal strip radiates at least one first resonant mode, and the second radiating metal strip is coupled to the first radiating metal strip to produce at least one second resonant mode; the resonant paths are switched via the connecting circuit, so that the frequency of the second resonant mode varies between different values.

15. The antenna according to claim 14, wherein an area surrounded by the grounding metal strip, the connecting circuit, and the second radiating metal strip is substantially an U shape, and the first radiating metal strip is located within the area.

16. The antenna according to claim 14, wherein the first radiating metal strip has a feed point, the grounding metal strip has a grounding point, and the feed point and the grounding point are respectively electrically connected to a signal end and a grounding end of a coaxial line.

17. The antenna according to claim 14, wherein the connecting circuit comprises a first switching circuit, and the first switching circuit electrically connects the different positions on the grounding metal strip and on the second radiating metal strip.

18. The antenna according to claim 14, wherein the connecting circuit comprises a second switching circuit and a connecting portion, the connecting portion is located on the first surface of the substrate and connects the grounding metal strip and the second radiating metal strip, the second switching circuit is located between the first radiating metal strip and the connecting portion, the second switching circuit has an open circuit state, and the grounding metal strip is not electrically connected to the second radiating metal strip under the open circuit state.

19. The antenna according to claim 18, wherein the connecting portion is a connecting metal strip, and the grounding metal strip, the connecting metal strip, and the second radiating metal strip are integrally formed.

20. The antenna according to claim 18, further comprising at least one first wiring and at least one second wiring, wherein the grounding metal strip has at least one first electrical connection point, the second radiating metal strip has at least one second electrical connection point, the at least one first wiring is connected to the at least one first electrical connection point and the second switching circuit, and the at least one second wiring is connected to the at least one second electrical connection point and the second switching circuit.

21. The antenna according to claim 14, wherein the grounding metal strip has at least one first electrical connection point, the second radiating metal strip has at least one second electrical connection point, and the connecting circuit is electrically connected to the at least one first electrical connection point and the at least one second electrical connection point.

22. The antenna according to claim 21, further comprising at least one first wiring and at least one second wiring, wherein the at least one first wiring is connected to the at least one first electrical connection point and the connecting circuit, and the at least one second wiring is connected to the at least one second electrical connection point and the connecting circuit.
